(19) United States
(12) Patent Application Publication
(10) Pub. No.: US 2017/0148290 A1
(43) Pub. Date: May 25, 2017

(54) ANTI-THEFT ALARM SYSTEM AND METHOD

(71) Applicant: BOE TECHNOLOGY GROUP CO., LTD., Beijing (CN)

(72) Inventors: Tian YANG, Beijing (CN); Wenbo LI, Beijing (CN)

(21) Appl. No.: 15/112,321

(22) PCT Filed: Dec. 10, 2015
(86) PCT No.: PCT/CN2015/097022

§ 371 Date: Jul. 18, 2016

(30) Foreign Application Priority Data
Jul. 20, 2015 (CN) 201510428128.2

(51) Int. Cl. G08B 13/196; G06K 9/00

(52) U.S. Cl. CPC G08B 13/196; G06K 9/00892; G06K 9/00087; G06K 9/00617; G06K 9/00295

(57) ABSTRACT

The present invention relates to an anti-theft alarm system and method, the system comprising: an eye detection unit configured to detect whether there is an eye in a target area, and generate first trigger information if there is the eye in the target area; an eye recognition unit configured to recognize eye information upon receiving the first trigger information, compare the recognized eye information with pre-stored eye information, and send second trigger information to an alarming unit if the recognized eye information does not match the pre-stored eye information; and the alarming unit configured to send alarm information upon receiving the second trigger information. According to an exemplary embodiment of the present invention, alarm information may be sent upon detection of an eye, which is capable of more accurately monitoring whether an unauthorized person exists within a preset area where items are placed, thus improving security.

The present application claims the benefit and priority of Chinese Patent Application No. 201510428128.2, filed on Jul. 20, 2015, the disclosure of which is entirely incorporated herein by reference as a part of the present application.

### FIELD

Exemplary embodiments of the present invention relate to an anti-theft alarm system and method.

### BACKGROUND

With increasing development of criminal skills and improvement in technique, higher standard and requirement are imposed on a security system. However, a current security sensing system mainly employs infrared detection, which has defects that anti-theft performance is low, false determination is prone to occur, infrared rays may be selectively avoided, and so on. Therefore, a current anti-theft system has low security coefficient and is difficult to satisfy high-level security requirement (e.g., in locations where important items are placed, such as in bank, jewelry fair, museum, and so on).

In prior art, there is also a technology that employs face recognition to realize anti-theft, however, the face recognition technology needs to compare a recognized face with faces pre-stored in a database so as to make determination, the determination process is relative complex. Furthermore, since comparison needs to be conducted, there is still possibility of false determination. Moreover, an unauthorized person, when stealing an item, may be wearing a mask to conduct theft behavior. It is difficult for a current face recognition device to detect a thief wearing a mask, if whether an alarm needs to be given is judged according to whether a face has been detected, thus causing degradation in security performance.

### SUMMARY

An anti-theft alarm system and method provided in accordance with exemplary embodiments of the present invention are capable of improving ability to recognize an unauthorized person, and improving security performance of an anti-theft system.

According to an aspect of the present invention, there is provided an anti-theft alarm system, the system comprising:

an eye detection unit configured to detect whether there is an eye in a target area, and generate first trigger information if there is the eye in the target area;

an eye recognition unit configured to recognize eye information upon receiving the first trigger information, compare the recognized eye information with pre-stored eye information, and send second trigger information to an alarming unit if the recognized eye information does not match the pre-stored eye information; and

the alarming unit configured to send alarm information upon receiving the second trigger information.

According to an exemplary embodiment of the present invention, the system further comprising:

a switching unit configured to turn on the eye detection unit during a target time period and turn off the eye detection unit during a non-target time period.

According to an exemplary embodiment of the present invention, the system further comprising:

a first prompt unit configured to send eye recognition information upon receiving the first trigger information,

wherein, the eye recognition unit is configured to send the second trigger information to the alarming unit if it does not recognize the eye information within a preset time period.

According to an exemplary embodiment of the present invention, the system further comprising:

a second prompt unit configured to send face recognition information upon receiving the first trigger information; and

a face recognition unit configured to recognize a face where the eye is located, compare the recognized face information with pre-stored face information, and send the second trigger information to the alarming unit if the recognized face information does not match the pre-stored face information.

According to an exemplary embodiment of the present invention, the face recognition unit is configured to send the second trigger information to the alarming unit if it does not recognize the face information within a preset time period.

According to an exemplary embodiment of the present invention, the system further comprising:

a third prompt unit configured to send fingerprint recognition information upon receiving the first trigger information;

a fingerprint recognition unit configured to recognize fingerprint information, compare the recognized fingerprint information with pre-stored fingerprint information, and send the second trigger information to the alarming unit if the recognized fingerprint information does not match the pre-stored fingerprint information.

According to an exemplary embodiment of the present invention, the fingerprint recognition unit is configured to send the second trigger information to the alarming unit if it does not recognize the fingerprint information within a preset time period.

According to an exemplary embodiment, the system further comprising:

a storage unit configured to store the pre-stored eye information, the pre-stored face information and the pre-stored fingerprint information.

According to an exemplary embodiment of the present invention, the system further comprising:

an anti-theft door switching unit, a dialing unit and/or an alarm,

wherein, the alarming unit is configured to send alarm information to the anti-theft door switching unit upon receiving the second trigger information to close the anti-theft door, and/or to send alarm information to the dialing unit to dial a preset number, and/or to send alarm information to the alarm to send audio and/or optical information.

According to another aspect of the present invention, there is provided an anti-theft alarm method, the method comprising:

detecting whether there is an eye in a target area, and generating first trigger information if there is the eye in the target area;

recognizing eye information upon receiving the first trigger information, comparing the recognized eye information with pre-stored eye information, and generating second trigger information if the recognized eye information does not match the pre-stored eye information; and

sending alarm information upon receiving the second trigger information.

According to an exemplary embodiment of the present invention, the method further comprising:

sending eye recognition information upon receiving the first trigger information;

generating the second trigger information if eye information has not been recognized within a preset time period.

According to an exemplary embodiment of the present invention, the method further comprising:

sending face recognition information upon receiving the first trigger information;

recognizing a face where the eye is located, comparing the recognized face information with pre-stored face information, and generating the second trigger information if the recognized face information does not match the pre-stored face information.

According to an exemplary embodiment of the present invention, the second trigger information is sent to the alarming unit if face information has not been recognized within a preset time period.

According to an exemplary embodiment of the present invention, the method further comprising:

sending fingerprint recognition information upon receiving the first trigger information;

recognizing fingerprint information, comparing the recognized fingerprint information with pre-stored fingerprint information, and generating the second trigger information if the recognized fingerprint information does not match the pre-stored fingerprint information.

According to an exemplary embodiment of the present invention, the second trigger information is sent to the alarming unit if the fingerprint information has not been recognized within a preset time period.

According to an exemplary embodiment of the present invention, the method further comprising: storing the pre-stored eye information, the pre-stored face information and the pre-stored fingerprint information.

According to exemplary embodiments of the present invention, alarm information may be sent upon detection of an eye, which is capable of more accurately monitoring whether an unauthorized person exists within a preset area where items are placed, thus improving security.

### DRAWINGS

To illustrate embodiments of the invention or technical solutions in the prior art more clearly, drawings need to be used in describing the embodiments or the prior art will be introduced briefly, apparently, the drawings in the following description are merely some embodiments of the invention, and other drawings may be obtained from these drawings by a person skilled in the art without paying any inventive work.

FIG. 1 shows a structure block diagram of an anti-theft alarm system according to an exemplary embodiment of the present invention;

FIG. 2 is a schematic diagram showing signal flow direction in an anti-theft alarm system according to an exemplary embodiment of the present invention;

FIG. 3 is a schematic diagram showing an alarm manner according to another exemplary embodiment of the present invention; and

FIG. 4 is a flowchart of an anti-theft alarm method according to an exemplary embodiment of the present invention.

### DETAILED DESCRIPTION

Hereinafter, technical solutions of embodiments of the invention will be described clearly and completely in conjunction with drawings in embodiments of the invention. Apparently, the described embodiments are just part of rather than all of the embodiments of the invention. Based on the described embodiments, all other embodiments obtained by those skilled in the art without any inventive work are within protection scope of the invention.

In addition, in the present invention, terms such as “first”, “second”, “third”, and so on are only used for purpose of description, and should not be construed as to indicate or imply relative importance. The term “a plurality of” as used herein refers to two or more, unless explicitly defined otherwise.

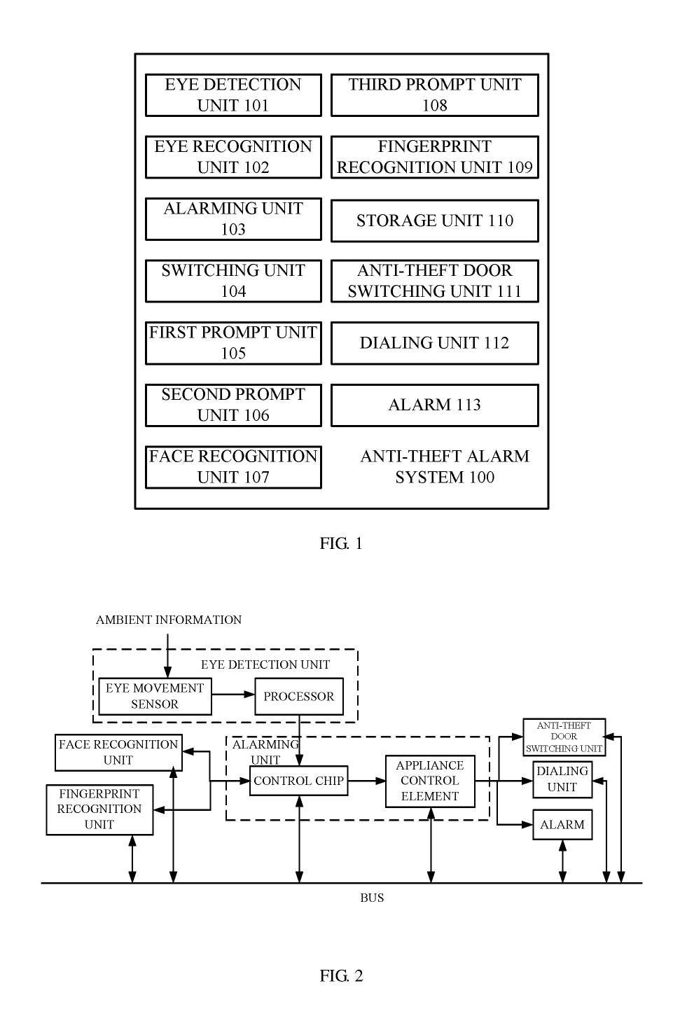

As shown in FIG. 1, an anti-theft alarm system 100 according to an exemplary embodiment of the present invention comprises an eye detection unit 101, an eye recognition unit 102, an alarming unit 103, a switching unit 104, a first prompt unit 105, a second prompt unit 106, a face recognition unit 107, a third prompt unit 108, a fingerprint recognition unit 109, a storage unit 110, an anti-theft door switching unit 111, a dialing unit 112 and an alarm 113, hereinafter, the units or components contained in the anti-theft alarm system 100 will be described in detail.

The eye detection unit 101 is configured to detect whether there is an eye in a target area, and generate first trigger information if there is the eye in the target area.

The eye recognition unit 102 is configured to recognize eye information upon receiving the first trigger information, compare the recognized eye information with pre-stored eye information, and send second trigger information to the alarming unit 103 if the recognized eye information does not match the pre-stored eye information.

The alarming unit 103 is configured to send alarm information upon receiving the second trigger information.

The switching unit 104 is configured to turn on the eye detection unit 101 during a target time period and turn off the eye detection unit 101 during a non-target time period. For example, during exhibition of an item or when a bank safe is being used, it is unnecessary to monitor an eye to send alarm information, therefore, the eye detection unit 101 can be set to be turned on only in a target time period by the switching unit 104, so as to on one hand, lower power consumption, and on the other hand, to avoid false determination operation. It is noted that the target time period may be nonworking days and/or night of working days.

The first prompt unit 105 is configured to send eye recognition information upon receiving the first trigger information, to prompt the eye recognition unit 102 to conduct eye recognition on a person in the target area.

In some exemplary embodiments, the eye recognition unit 102 is configured to send the second trigger information to the alarming unit 103 if it does not recognize the eye information within a preset time period. In this case, if eye information has not been recognized during the preset time period, that is, eye recognition has not been conducted by the person in the target area, it means that the person knows by himself that he is an unauthorized person, and that his own eye information does not match the pre-stored eye information, and therefore, he dares not to conduct eye recognition. Thus, it can be determined that the person is an unauthorized person, and hence the alarm information is sent.

The second prompt unit 106 is configured to send face recognition information upon receiving the first trigger information, to prompt the face recognition unit 107 to conduct face recognition on the person in the target area.

The face recognition unit 107 is configured to recognize a face where the eye is located, compare the recognized face information with pre-stored face information, and send the second trigger information to the alarming unit 103 if the recognized face information does not match the pre-stored face information.

In some exemplary embodiments, the face recognition unit 107 is configured to send the second trigger information to the alarming unit 103 when face information has not been recognized within a preset time period. In this case, if face information has not been recognized within the preset time period, that is, face recognition has not been conducted by the person in the target area, it means that the person knows by himself that he is an unauthorized person, and that his own face information does not match the pre-stored face information, and therefore, he dares not to conduct face recognition. Thus, it can be determined that the person is an unauthorized person, and hence the alarm information is sent. Alternatively, if the person in the target area is wearing a mask and face information cannot be recognized, then it can also be determined that the person is an unauthorized person and hence the alarm information is sent.

In a particular situation, accuracy of the alarm may be improved by further recognizing a face. For example, during patrolling by a security at night, when the security is within the above target area, eyes of the security can be detected, and further, face information of the security person can be detected, it may be determined that the face information conforms to the pre-stored face information, then the alarm information will not be sent, However, if the recognized face information does not match the pre-stored face information, it means that the person in the target area is indeed an unauthorized person, and then the alarm information is sent.

The third prompt unit 108 is configured to send fingerprint recognition information upon receiving the first trigger information, to prompt the fingerprint recognition unit 109 to conduct fingerprint recognition on the person in the target area.

The fingerprint recognition unit 109 is configured to recognize fingerprint information, compare the recognized fingerprint information with pre-stored fingerprint information, and send the second trigger information to the alarming unit 103 if the recognized fingerprint information does not match the pre-stored fingerprint information.

After an eye is detected by the eye detection unit 101, in order to avoid false alarm, the person within the preset area may be prompted by the third prompt unit 108 to conduct fingerprint recognition, and fingerprint information is recognized through the fingerprint recognition unit 109, if the recognized fingerprint information does not match the pre-stored fingerprint information, or the person in the preset area is an unauthorized person, then the alarm information is sent, thus false alarm can be reduced, and accuracy of alarm can be improved.

It is to be noted that the above first prompt unit 105, the second prompt unit 106 and the third prompt unit 108 may be integrated, or may be provided as three separate units.

In some exemplary embodiments, the fingerprint recognition unit 109 is configured to send the second trigger information to the alarming unit 103 when the fingerprint information has not been recognized within a preset time. In this case, if the fingerprint information has not been recognized within a preset time period, that is, fingerprint recognition has not been conducted by the person in the target area, it means that the person knows by himself that he is an unauthorized person, and that his own fingerprint information does not match the pre-stored fingerprint information, and therefore, he dares not to conduct fingerprint recognition. Thus, it can be determined that the person is an unauthorized person, and hence the alarm information is sent.

The storage unit 110 is configured to store the pre-stored eye information, the pre-stored face information and the pre-stored fingerprint information.

The anti-theft door switching unit 111 is configured to close the anti-theft door according to the alarm information received from the alarming unit 103.

The dialing unit 112 is configured to dial a preset number (e.g. dial 110, and send preset voice information so as to call police in time) according to the alarm information received from the alarming unit 103.

The alarm 113 is configured to send audio and/or optical information according to the alarm information received from the alarming unit 103.

Hereinafter, the above units or components and signal flow directions therebetween will be further described with reference to FIG. 2.

As shown in FIG. 2, the eye detection unit 101 may comprise an eye movement sensor, wherein the eye movement sensor comprises a first infrared element and a first eye ball position sensor, the first infrared element emits infrared light towards the target area, and the first eye ball position sensor is arranged adjacent to the first infrared element, receives infrared light (mainly the infrared light from the first infrared element) reflected by the eye (e.g. eye ball and cornea) in the target area, and computes positional relationship between the eye and the first eye ball position sensor and vector relationship between a gazing direction of the eye and the first eye ball position sensor.

In some exemplary embodiments, the eye movement sensor further comprises a second infrared element and a second eye ball position sensor. The second infrared element has the same function as the first infrared element, but is arranged at different position from the first infrared element. The second eye ball position sensor is arranged adjacent to the second infrared element, receives infrared light (mainly the infrared light from the second infrared element) reflected from the eye in the target area, and computes positional relationship between the eye and the second eye ball position sensor and vector relationship between a gazing direction of the eye and the second eye ball position sensor.

When the reflected infrared light is received by the first eye ball position sensor and/or the second eye ball position sensor, it can be determined that an eye exists in the target area.

When stealing an item, an authorized person still will expose his eyes to observe the item or an area (such as an exhibition window, an exhibition stage etc) where the item is placed, even if he is wearing a mask to conduct theft behavior. That is to say, even if the face of the unauthorized person is hard to be detected, his eyes can still be detected. According to the exemplary embodiment of the present invention, upon detection of an eye, the alarm information may be sent without detecting the face, thus it is possible to more accurately and timely detect whether an unauthorized person exists in the target area where an item is placed and send the alarm information, thus improving security.

After an eye is detected by the eye detection unit 101, in order to avoid false alarm, eye information may be recognized through the eye recognition unit 102, if the recognized eye information does not match the pre-stored eye information, it can be determined that the person in the target area is an unauthorized person, and alarm information is sent. According to the exemplary embodiment of the present invention, it is possible to reduce false alarm operation and improve accuracy of the alarm.

According to an exemplary embodiment of the present invention, the eye detection unit 101 further comprises a processor configured to calculate a three dimensional vector of the gazing direction of the eye according to the above two sets of positional relationship and vector relationship, and generate the first trigger information when the three dimensional vector of the gazing direction of the eye is located at a specified area for a time period exceeding a specified time period. Wherein, the specified area can be a lock of an exhibition stage, a lock of a safe, an area in an exhibition room where a monitoring camera is located, and so on. When the three dimensional vector of the gazing direction of the eye aims at the above area for a time period excessing the specified time period, it means that the person pays too much attention on the above area, that is, the person is unduly interested in the security equipment and is suspected of conducting theft, therefore, the second trigger information may also be sent.

As shown in FIG. 2, the alarming unit 103 comprises a control chip and an appliance control element, the control chip is configured to send a control signal to the appliance control element upon receiving the second trigger information, so as to control corresponding appliances (e.g. the anti-theft door switching unit, the dialing unit and the alarm, etc.) to act accordingly. Wherein, the control chip, the appliance control element, the face recognition unit 107, the fingerprint recognition unit 109, and the appliances are all connected to a bus to communicate information resource with each other.

In some exemplary embodiments, the control chip may also be configured to control the face recognition unit 107 and/or the fingerprint recognition unit 109 to be turned on through the bus upon receiving the first trigger information, and hence the face information and/or fingerprint information is recognized.

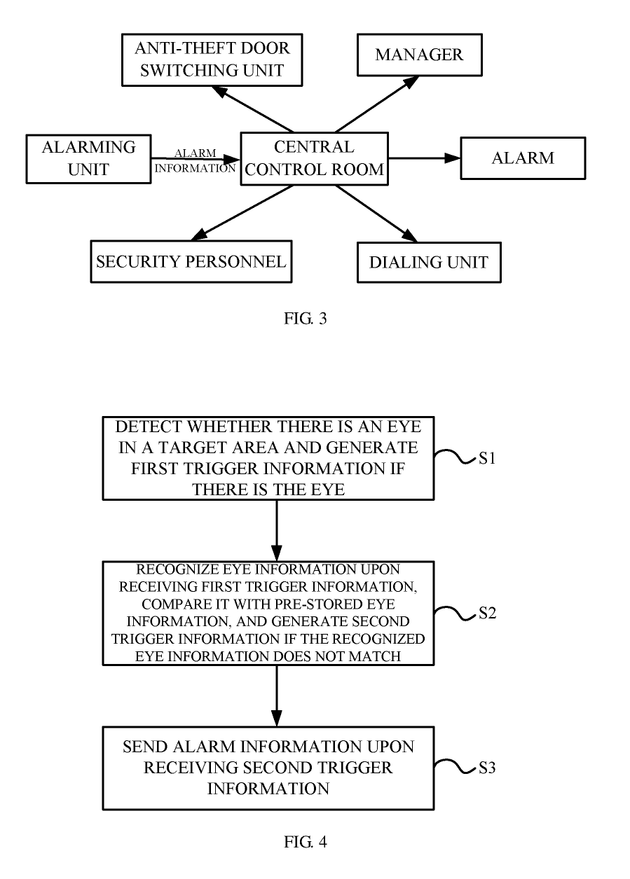

According to an exemplary embodiment of the present invention, as shown in FIG. 3, in addition to directly sending the alarm information to the anti-theft door switching unit 111, the dialing unit 112 and/or the alarm 113, the alarming unit 103 may also be configured to first send the alarm information to a central control room (e.g. a surveillance center), and then the alarm information is sent to the management staffs (e.g. management staffs in a museum) and/or security persons (e.g. security persons in a bank) from the central control room to facilitate entering into full alert state. Of course, specific reaction manner to the alarm information may be specifically set according to actual needs.

It is to be noted that, the above operation for receiving the first and/or second trigger information may be an active receiving operation, for example, actively acquiring the first trigger information from the eye detection unit 101 periodically, or may be a passive receiving operation, for example, waiting for the eye detection unit 101 to send the first trigger information. It should be noted that, the alarm 113 may conduct the prompt by means of voice and/or light.

According to an exemplary embodiment of the present invention, as shown in FIG. 4, there is further provided an anti-theft alarm method comprising:

S1, detecting whether there is an eye in a target area, and generating first trigger information if there is the eye in the target area;

S2, recognizing eye information upon receiving the first trigger information, comparing the recognized eye information with pre-stored eye information, and generating second trigger information if the recognized eye information does not match the pre-stored eye information; and

S3, sending alarm information upon receiving the second trigger information.

According to an exemplary embodiment of the present invention, the anti-theft alarm method further comprising:

sending eye recognition information upon receiving the first trigger information;

generating the second trigger information if eye information has not been recognized within a preset time period.

According to an exemplary embodiment of the present invention, the anti-theft alarm method further comprising:

sending face recognition information upon receiving the first trigger information;

recognizing a face where the eye is located, comparing the recognized face information with pre-stored face information, and generating the second trigger information if the recognized face information does not match the pre-stored face information.

According to an exemplary embodiment of the present invention, the second trigger information is sent to the alarming unit if face information has not been recognized within a preset time period.

According to an exemplary embodiment of the present invention, the anti-theft alarm method further comprising:

sending fingerprint recognition information upon receiving the first trigger information;

recognizing fingerprint information, comparing the recognized fingerprint information with pre-stored fingerprint information, and generating the second trigger information if the recognized fingerprint information does not match the pre-stored fingerprint information.

According to an exemplary embodiment of the present invention, the second trigger information is sent to the alarming unit if the fingerprint information has not been recognized within a preset time period.

According to an exemplary embodiment of the present invention, the anti-theft alarm method further comprising: storing the eye information, the face information and the fingerprint information in advance.

The technical solution of the present invention has been described in detail hereinabove with reference to attached drawings in consideration of the prior art in which it is difficult to accurately conduct alarm determination when face information of an unauthorized person cannot be detected. Whereas, according to exemplary embodiments of the present invention, alarm information can be sent upon detection of an eye, therefore, it is capable of more accurately monitoring whether an unauthorized person exists within a preset area where items are placed, thus improving security.

The foregoing is merely detailed embodiments of the invention, however, protection scope of the invention is not limited thereto, within technical scope disclosed by the present invention, variations or substitutions readily occurred to a person skilled in the art should be covered by the protection scope of the invention. Therefore, protection scope of the invention should be defined by accompany claims.

1. An anti-theft alarm system comprising:
an eye detection unit configured to detect whether there is an eye in a target area, and generate first trigger information if there is the eye in the target area;
an eye recognition unit configured to recognize eye information upon receiving the first trigger information, compare the recognized eye information with pre-stored eye information, and send second trigger information to an alarming unit if the recognized eye information does not match the pre-stored eye information; and
the alarming unit configured to send alarm information upon receiving the second trigger information.

2. The anti-theft alarm system according to claim 1, further comprising:
a switching unit configured to turn on the eye detection unit during a target time period and turn off the eye detection unit during a non-target time period.

3. The anti-theft alarm system according to claim 1, further comprising:
a first prompt unit configured to send eye recognition information upon receiving the first trigger information,
wherein the eye recognition unit is configured to send the second trigger information to the alarming unit if it does not recognize the eye information within a preset time period.

4. The anti-theft alarm system according to claim 1, further comprising:
a second prompt unit configured to send face recognition information upon receiving the first trigger information; and
a face recognition unit configured to recognize a face where the eye is located, compare the recognized face information with pre-stored face information, and send the second trigger information to the alarming unit if the recognized face information does not match the pre-stored face information.

5. The anti-theft alarm system according to claim 4, wherein the face recognition unit is configured to send the second trigger information to the alarming unit if it does not recognize the face information within a preset time period.

6. The anti-theft alarm system according to claim 1, further comprising:
a third prompt unit configured to send fingerprint recognition information upon receiving the first trigger information;
a fingerprint recognition unit configured to recognize fingerprint information, compare the recognized fingerprint information with pre-stored fingerprint information, and send the second trigger information to the alarming unit if the recognized fingerprint information does not match the pre-stored fingerprint information.

7. The anti-theft alarm system according to claim 6, wherein, the fingerprint recognition unit is configured to send the second trigger information to the alarming unit if it does not recognize the fingerprint information within a preset time period.

8. The anti-theft alarm system according to claim 1, further comprising:
a storage unit configured to store the pre-stored eye information, the pre-stored face information and the pre-stored fingerprint information.

9. The anti-theft alarm system according to claim 1, further comprising:
an anti-theft door switching unit, a dialing unit and/or an alarm,
wherein the alarming unit is configured to send alarm information to the anti-theft door switching unit upon receiving the second trigger information to close the anti-theft door, and/or to send alarm information to the dialing unit to dial a preset number, and/or to send alarm information to the alarm to send audio and/or optical information.

10. An anti-theft alarm method comprising:
detecting whether there is an eye in a target area, and generating first trigger information if there is the eye in the target area;
recognizing eye information upon receiving the first trigger information, comparing the recognized eye information with pre-stored eye information, and generating second trigger information if the recognized eye information does not match the pre-stored eye information; and
sending alarm information upon receiving the second trigger information.

11. The anti-theft alarm method according to claim 10, further comprising:
sending eye recognition information upon receiving the first trigger information;
generating the second trigger information if eye information has not been recognized within a preset time period.

12. The anti-theft alarm method according to claim 10, further comprising:
sending face recognition information upon receiving the first trigger information;
recognizing a face where the eye is located, comparing the recognized face information with pre-stored face information, and generating the second trigger information if the recognized face information does not match the pre-stored face information.

13. The anti-theft alarm method according to claim 12, wherein the second trigger information is sent to the alarming unit if face information has not been recognized within a preset time period.

14. The anti-theft alarm method according to claim 10, further comprising:
sending fingerprint recognition information upon receiving the first trigger information;
recognizing fingerprint information, comparing the recognized fingerprint information with pre-stored fingerprint information, and generating the second trigger information if the recognized fingerprint information does not match the pre-stored fingerprint information.

15. The anti-theft alarm method according to claim 14, wherein the second trigger information is sent to the alarming unit if the fingerprint information has not been recognized within a preset time period.

16. The anti-theft alarm method according to claim 10, further comprising: storing the pre-stored eye information, the pre-stored face information and the pre-stored fingerprint information.

17. The anti-theft alarm system according to claim 2, further comprising:
a first prompt unit configured to send eye recognition information upon receiving the first trigger information,
wherein the eye recognition unit is configured to send the second trigger information to the alarming unit if it does not recognize the eye information within a preset time period.

18. The anti-theft alarm system according to claim 2, further comprising:
a second prompt unit configured to send face recognition information upon receiving the first trigger information; and
a face recognition unit configured to recognize a face where the eye is located, compare the recognized face information with pre-stored face information, and send the second trigger information to the alarming unit if the recognized face information does not match the pre-stored face information.

19. The anti-theft alarm system according to claim 3, further comprising:
a second prompt unit configured to send face recognition information upon receiving the first trigger information; and
a face recognition unit configured to recognize a face where the eye is located, compare the recognized face information with pre-stored face information, and send the second trigger information to the alarming unit if the recognized face information does not match the pre-stored face information.

20. The anti-theft alarm method according to claim 11, further comprising:
sending face recognition information upon receiving the first trigger information;
recognizing a face where the eye is located, comparing the recognized face information with pre-stored face information, and generating the second trigger information if the recognized face information does not match the pre-stored face information.
